(19) United States
(12) Patent Application Publication
(10) Pub. No.: US 2014/0283078 A1
(43) Pub. Date: Sep. 18, 2014

(54) SCANNING AND FILTERING OF HOSTED CONTENT

(71) Applicant: Go Daddy Operating Company, LLC, Scottsdale, AZ (US)

(72) Inventors: Todd Redfoot, Phoenix, AZ (US); David C. Allmon, Glendale, AZ (US); Christopher Coriale, Phoenix, AZ (US); Zane Daniels, Apache Junction, AZ (US); Truance Pierson, Mesa, AZ (US); Ganesh Devarajan, Phoenix, AZ (US)

(21) Appl. No.: 13/896,742

(22) Filed: May 17, 2013

Related U.S. Application Data
(60) Provisional application No. 61/789,506, filed on Mar. 15, 2013.

(51) Int. Cl. H04L 29/06

(52) U.S. Cl. CPC H04L 63/1441; H04L 63/145
USPC 726/24; 726/23

(57) ABSTRACT

A system includes a server computer configured to host a plurality of web pages. A scanner is configured to scan the plurality of web pages to identify malicious links contained in the plurality of web pages. A proxy server is configured to filter the malicious links from content of the plurality of web pages served from the server computer to a user in response to a request from the user.

### CROSS-REFERENCE TO RELATED APPLICATIONS

This application claims priority to and incorporates by reference U.S. Provisional Patent Application 61/789,506 filed Mar. 15, 2013 and entitled “SCANNING OF HOSTED CONTENT.”

### BACKGROUND

Web sites have become a major portal for communication and collaboration between users, companies, and organizations. At the same time, sometimes web sites are used to host malicious content to compromise personal and business computers, steal financial resources, and launch network attacks. After malicious content has been installed into a page of a particular target web site, when a user visits the web site, the user's browser downloads the malicious content and, if the content is appropriately configured, the user's computer executes the code associated with the malicious content. The code, when executed, may cause the user's computer to transmit confidential or private data (such as banking information, passwords, and the like) to a third party, perform illegal activities, or otherwise violate the security of the user. In other cases, malicious content may be used to perform phishing attacks whereby users are misled into divulging personal information.

In the vast majority of cases, malicious content is installed into a web site without the knowledge of the web site administrator. In some cases, however, the malicious content is installed with the web site administrator's knowledge. In either case, when the web page of the web site containing malicious content has been visited by a user's web browser, it is often too late and the malicious content has already been downloaded and executed by the user's computer.

Although some anti-virus solutions exist that make an attempt to monitor a user's browsing activities (and thereby protect the user against web sites hosting malicious content), those anti-virus solutions require regular updating in order to be effective. If the virus signature database of those anti-virus solutions should become out of date, the solutions become quite ineffective at detecting and protecting against malicious content. Additionally, many computer users are not savvy with regards to computer security and often fail to install or maintain anti-virus protection. As a result, web sites including malicious code or content are increasingly becoming a common attack vector for computer viruses, phishing schemes, and the like.

Should malicious content be installed onto a web site (in most cases, without the administrator's knowledge), there can be severe consequences for the web site. Once a web site has been identified as containing malicious content (or links to such malicious content) a number of online services may rank that web site as being untrustworthy. Once a web site has a reputation as being untrustworthy, even after the malicious content has been removed from the web site, users may continue to be warned by these online services to avoid the web site. Accordingly, even after the malicious content has been removed and the web site poses no risks to users, the web site may see a severe reduction in traffic, greatly affecting the administrator's business.

### DESCRIPTION OF THE DRAWINGS

FIG. 1 is an illustration showing a conventional environment in which a user accesses web site content.

FIG. 2 is a flowchart illustrating an example method for identifying potential links to malicious content on a web site.

FIG. 3 is an illustration showing an environment in which a user accesses web site content in accordance with the present disclosure.

FIG. 4 is screenshot showing an example user interface for managing potential threats associated with a web site.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as web pages. Websites comprise a collection of connected, or otherwise related, web pages. The combination of all the websites and their corresponding web pages on the Internet is generally known as the World Wide Web (WWW) or simply the Web.

Web sites include a number of web pages that may be created using HyperText Markup Language (HTML) to generate a standard set of tags that define how the web pages for the website are to be displayed. Users of the Internet may access content providers' websites using software known as an Internet browser, such as MICROSOFT INTERNET EXPLORER or MOZILLA FIREFOX. After the browser has located the desired web page, the browser requests and receives information from the web page, typically in the form of an HTML document, and then displays the web page content for the user. A request is made by visiting the website's address, known as a Uniform Resource Locator (“URL”). The user then may view other web pages at the same website or move to an entirely different website using the browser.

FIG. 1 is an illustration showing a conventional environment in which a user accesses web site content. As shown in FIG. 1, environment 100 includes a hosting grid 102 configured to serve web site content. Hosting grid 102 may include a number of web servers running on a number of physical web server computers and/or virtual machines. Hosting grid 102 may serve content for a number of different web sites, where each web site has a varying number of web pages. The web pages for each web site may include content, such as text, images, and video, code, such as javascript, and links to one or more web pages, where the web pages may be part of the original web site or located at other web sites. The linked-to web sites may be hosted by hosting grid 102, or may be hosted by other server computers.

In the present example, one or more of the web pages hosted by hosting grid 102 includes malicious content. This malicious content may include code that is directly present within an infected web page. In that case, the malicious code may be present within javascript, java, or some other program encoded within the web page itself. When the malicious code is directly present within the infected web page, upon loading the web page, the malicious code is directly executed by the user's computer.

Alternatively, rather than directly incorporate the malicious content, the infected web page may instead link to another web page or file (e.g., via an <img> tag, <frame> tag, <audio> tag, and/or <video> tag), where the linked-to web page or file includes the malicious content. For example, the malicious link may point directly to a file, such as an image, document (e.g., pdf), video file, or flash file, for example, that includes the malicious content. In that case, upon loading the web page containing the malicious link, the user's browser will follow the link and download the linked-to file containing the malicious content. Because the malicious content is contained within a linked-to file, that file may be stored on a web server that is not part of hosting grid 102.

Alternatively, the web page may include a hyperlink to another web page that itself contains the malicious content. In that case, upon loading the first web page, the malicious code is not immediately retrieved or executed. But should the user clink upon the malicious link, the user's browser will visit the linked-to web page and potentially retrieve and execute the malicious content.

With reference to FIG. 1, therefore, hosting grid 102 hosts a number of web sites comprising a number of web pages that can be transmitted to requesting devices using communications network 104. Network 104 may include the Internet, a local area network (LAN), or another network configured to enable electronic devices to communicate.

User 106, via network 104, transmits a request using a suitable computing device (e.g., a desktop computer, laptop computer, mobile device, or tablet) to hosting grid 102 for a particular web page. In one implementation, the request transmitted by user 106 includes a uniform resource locator (URL) identifying the requested web page. The content associated with the requested web page is retrieved by hosting grid 102 and transmitted back to user 106 for display on the user's computing device.

As discussed above, in some cases, the content associated with the requested web page may include malicious code that, once retrieved from hosting grid 102, may be installed on or executed by the computing device of user 106 or malicious content that may be part of a phishing scheme, for example.

In the present system, therefore, to prevent the user from inadvertently retrieving malicious content from a web server or other source, the present disclosure provides a system configured to scan a target web site for potential malicious content (either embedded directly in the web site's code, or linked-to by the web pages of the target web site). The scan allows the system to identify potentially malicious links or web pages that can then be filtered from the content transmitted to the user in response to a web page request. In this manner, the user can be insulated from that malicious content.

Once a link to the malicious content has been identified, a web site administrator may be notified so that the administrator can remove the link to the malicious content from their web site. In the present system, this process may be automated and may be performed using a software application, described below. Additionally, the present system provides a proxy server configured to intercept malicious links in the web pages of web sites that are being requested by a user. Once intercepted, the malicious links can be removed from the requested web page so that the malicious links (and, thereby, the malicious code) do not reach the user's requesting computer device and, as such, cannot be executed by the computing device.

By removing the malicious content from a web site at the proxy, the web site will no longer serve malware code and/or links to the site's visitors. This prevents the web site from being banned by various third party services that monitor the reputation of web sites based upon their having previously served malicious content and protects users that wish to access the web site.

FIG. 2 is a flowchart illustrating an example method for identifying potential links to malicious code on a web site. In step 200, a target web site is scanned for malicious content. This may involve scanning through a number of web pages belonging to the web site, where each web page may include different content and different code. The scanning may involve directly scanning the code making up each page of the web site and determining whether the code itself includes malicious code. This may be done, for example, using a virus signature database, where the signatures for a large number of viruses can be compared to the code of the web pages of the web site. If a portion of the code of a web page matches one or more of the virus signatures in the virus signature database, the web page itself may be considered to be malicious. For example, in a particular web page, code embedded into the page's HTML (e.g., javascript) may include malicious code.

Additionally, the scanning of step 200 includes analyzing files or content that are linked to by the web pages of the web site to determine whether those linked-to files may contain malicious content or code. For example, a particular web page may include links to content, such as PDF files, flash files, images, video, and music files that may themselves include malicious content. Those linked-to files can be downloaded, scanned and compared to one or more virus signature databases to determine whether the linked-to files contain malicious code.

Finally, in a similar manner as described above, other web pages that are linked to by the web pages of the web site being scanned can, themselves, be analyzed to determine whether they contain malicious content or code. If it is determined that a web page being scanned links to another web page or file containing malicious code, the link that points to the malicious code is tagged as being malicious.

In addition to scanning the linked-to web pages for malicious content (e.g., by analyzing their content for potential virus signatures), the linked-to web pages can also be analyzed based upon their reputation. A number of online services exist that determine a trustworthiness reputation for different web pages. These services (e.g., GOOGLE safe browsing) identify web sites that are either currently serving, or have in the past served, as hosts for malware or phishing schemes. When scanning the web site, therefore, if one of the web pages being scanned includes a link to another web page that has a reputation for hosting malware or phishing schemes, that link can be designated as potentially malicious, even if the linked-to web page does not currently host such malware or phishing schemes. In this manner, the scan not only identifies malicious code that is present on the scanned web site (or linked to by one or more web pages of the web site), but the scan also identifies links to other web sites that have a reputation for hosting malware or phishing schemes.

Having scanned the website for malicious code in the web site's web pages (either in the form of malicious code embedded directly into one or more of the web pages, or a malicious link that points to malicious code), in step 202 each instance of malicious code or malicious links within the web site are identified in step 202.

Having identified a number of instances of malicious code or links on a particular web site, in step 204 the web site administrator (or another user accessing a control panel software for the web site) is presented with a listing of malicious code or malicious link present on the web page. The web site administrator can then indicate that one or more of the pieces of malicious code or links should be quarantined.

Upon indicating that a particular piece of malicious code or link should be quarantined, in step 206 a proxy server running between the web server hosting the website and the Internet is configured to block access to the malicious code. In the case that a web page of the web site includes malicious code (e.g., by including javascript that contains the malicious code), the proxy is configured to block access to that web page by both blocking links to that particular web page and blocking requests to load the web page itself. This prevents users from being able to directly request the web page that contains the malicious code.

In the event that a malicious link is identified on a web page (e.g., such as when a linked-to file contains malicious code, or a linked-to web page contains malicious code or has a reputation for hosting malware or phishing schemes), the proxy may be configured to simply remove the link from the content of the web page being requested. As such, the link never reaches the computing system of the user requesting the web page and, therefore, the user is unable to click on or otherwise activate the link, and the user's computer is not provided with a link to the malicious content and is consequently unable to retrieve the content. In this manner the user is shielded from the potential malicious code.

Having blocked the malicious code or link in the proxy server, requesting users are not served the malicious code or link and, therefore, the reputation of the web site is maintained. This provides the web site administrator with enough time to edit the web sites to remove the malicious code. Delays in this process will not result in the reputation of the web site being detrimentally affected.

FIG. 3 is a block diagram showing an environment 300 including functional components configured to implement the method of FIG. 2. FIG. 3 includes the hosting grid 102 of FIG. 1, as well as network 104, and user 106. But in FIG. 3, proxy 302 is disposed between hosting grid 102 and network 104.

As described with reference to FIG. 2, proxy 302 is configured to store a list of malicious links or web pages containing malicious code associated with one or more web sites hosted by hosting grid 102. Upon receiving a request for a particular web page from user 106, proxy 302 is configured to pass along the request to hosting grid 102 (although in some implementations the incoming request may bypass proxy 302). Proxy 302 then intercepts the web page content being transmitted from hosting grid 102 back to user 106 and analyzes that content for malicious links and/or code contained in the proxy 302's database. If a match is identified, the malicious code or links are removed from the content being transmitted back to user 106. As such, user 106 receives a web page that has been filtered to remove the malicious code or links. In one implementation, if the requested web page itself has been determined to contain malicious code embedded within the source code of the web page, and proxy 302 identifies a match with the requested web page itself, the entire web page is blocked and user 106 is unable to access the web page.

In some implementations, proxy 302 may be implemented as a plug-in or module running on one or more server computers that are part of hosting grid 102 or in communication with hosting grid 102. For example, proxy 302 may comprise a combination of modules for the Apache web server (such as mod_sed and/or mod_security) that may be utilized to execute the functionality of proxy 302. Proxy 302 also includes a database for storing the listing of web pages (stored, for example, as a listing of links) containing malicious code on hosting grid 102, as well as a listing of links that may point to malicious code or web sites that have a reputation for hosting malware or phishing schemes.

Scanner 304 is configured to access the content of web sites hosted by hosting grid 102 and analyze that content for potential malicious code or links. This may involve scanning the code of the various web pages for malicious program code. Additionally, the files and other web pages that may be linked-to in the web pages of the web sites can also be scanned for potential malicious code. In some cases, the reputation of the other web pages that are linked to are analyzed to determine whether the linked-to web page has a reputation for hosting malware or phishing schemes.

If scanner 304 detects potential malicious code or links, scanner 304 can provide a listing of links containing potentially malicious code to admin interface 306. Admin interface 306 enables a web site administrator to login and view a listing of potential malicious links or web pages on the administrator's web site. Upon being provided with the listing, the administrator can then take actions causing the links or web pages to be quarantined. Upon indicating that a particular link or web page should be quarantined, the link (or a link to the quarantined web page) is provided to proxy 302, where the link is stored in a database of proxy 302. Proxy 302's database of malicious links can then be consulted and used to intercept content as that content is being served up to user 106, as described above.

FIG. 4 is a screenshot showing an example user interface that may be displayed by admin interface 306 to an administrator of a web site. For a particular web site, interface 400 includes summary 402 of recent scanning activity for the web site. Summary 402 may include an identification of the last time a scan was performed, as well as the number of pages and links that were analyzed as part of the scanning process. Interface 400 may also include threat summary 404 that indicates a number of malware or malicious code instances, critical instances, warning instances, and informational instances associated with the administrator's web site.

If a number of potential malicious links have been identified in conjunction with the administrator's web site, they can be provided in listing 406. For each potentially malicious link, the administrator is provided with a number of user interfaces 408 allowing the administrator to find out more information about the potentially malicious link, ignore the link, or quarantine the link. As discussed above, upon quarantining the link, the link is transmitted to proxy 302, enabling the proxy to filter the link when the web page containing the link (or the web page identified by the link) is requested by a user.

Listing 406 also provides a summary describing various attributes of the potentially malicious link. For example, the summary may indicate whether a particular potentially malicious link points to a website that has been identified as untrustworthy, or whether the link includes a potentially malicious redirect. Listing 406 may also indicate that a particular link points to a file or webpage that contains malicious code, such as a virus. This additional information provided in listing 406 enables a web site administrator to make informed choices in determining whether to quarantine a particular link or to ignore the warning.

In some implementations, if the web site being scanned includes malicious code or potentially malicious links, the admin interface 400 will indicate that the web site has failed to meet certain safety and/or security requirements. This indication may be coupled with a revocation of the web site's safety seal. As such, web sites that have non-quarantined or ignored potentially malicious links may be identified as potentially dangerous web sites enabling users to avoid those web sites.

In one implementation, a system in accordance with the present disclosure includes a server computer configured to host a plurality of web pages, a scanner configured to scan the plurality of web pages to identify malicious links contained in the plurality of web pages, and a proxy server configured to filter the malicious links from content of the plurality of web pages served from the server computer to a user in response to a request from the user.

In another implementation, a method includes scanning a plurality of web pages hosted on a server computer to identify a malicious link, and transmitting an identification of the malicious link to a proxy server, the proxy server being configured to filter the malicious link from content served from the server computer, and, when the malicious link identifies content hosted by the server computer, prevent access to the content identified by the malicious link.

In another implementation, a method includes scanning a plurality of web pages hosted on a server computer to identify a plurality of malicious links, transmitting a list of the malicious links to a user, and receiving an instruction from the user to quarantine one of the malicious links.

As a non-limiting example, the steps described above (and all methods described herein) may be performed by any central processing unit (CPU) or processor in a computer or computing system, such as a microprocessor running on a server computer, and executing instructions stored (perhaps as applications, scripts, apps, and/or other software) in computer-readable media accessible to the CPU or processor, such as a hard disk drive on a server computer, which may be communicatively coupled to a network (including the Internet). Such software may include server-side software, client-side software, browser-implemented software (e.g., a browser plugin), and other software configurations.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A system, comprising:
a server computer configured to host a plurality of web pages;
a scanner configured to scan the plurality of web pages to identify malicious links contained in the plurality of web pages; and
a proxy server configured to filter the malicious links from content of the plurality of web pages served from the server computer to a user in response to a request from the user.

2. The system of claim 1, wherein the proxy server is configured to filter content associated with the malicious links from content served from the server computer.

3. The system of claim 1, wherein the malicious links include a link to a file containing malicious code.

4. The system of claim 1, wherein the malicious links include a link to a web page.

5. The system of claim 1, including an administration interface in communication with the server computer and being configured to display a listing of the malicious links.

6. The system of claim 5, wherein the administration interface is configured to receive user input indicating that one or more of the malicious links is to be quarantined.

7. The system of claim 6, wherein the administration interface is configured to transmit an identification of the one or more of the malicious links to the proxy server.

8. A method, comprising:
scanning a plurality of web pages hosted on a server computer to identify a malicious link; and
transmitting an identification of the malicious link to a proxy server, the proxy server being configured to:
filter the malicious link from content served from the server computer, and
when the malicious link identifies content hosted by the server computer, prevent access to the content identified by the malicious link.

9. The method of claim 8, wherein scanning the plurality of web pages includes comparing content of at least one of the plurality of web pages to a virus signature.

10. The method of claim 8, including determining whether the malicious link identifies a second web page that is untrustworthy.

11. The method of claim 10, including transmitting the malicious link to a third party to determine a trustworthiness of the second web page.

12. The method of claim 8, including determining whether the malicious link identifies a file containing malicious code.

13. The method of claim 12, wherein the file is not stored on the server computer.

14. A method, comprising:
scanning a plurality of web pages hosted on a server computer to identify a plurality of malicious links;
transmitting a list of the malicious links to a user; and
receiving an instruction from the user to quarantine one of the malicious links.

15. The method of claim 14, including, after receiving the instruction from the user to quarantine one of the malicious links, transmitting an identification of the one of the malicious links to a proxy server.

16. The method of claim 15, wherein the proxy server is configured to:
filter the one of the malicious links from content served from the server computer, and
when the one of the malicious links identifies content hosted by the server computer, prevent access to content identified by the one of the malicious links.

17. The method of claim 14, wherein scanning the plurality of web pages includes comparing content of at least one of the plurality of web pages to a virus signature.

18. The method of claim 14, including determining whether a link in the plurality of web pages identifies a second web page that is untrustworthy.

19. The method of claim 18, including transmitting the link in the plurality of web pages to a third party to determine a trustworthiness of the second web page.

20. The method of claim 14, including determining whether a link in the plurality of web pages points to a file containing malicious code.
